(19) United States
(12) Patent Application Publication
(10) Pub. No.: US 2022/0230262 A1
(43) Pub. Date: Jul. 21, 2022

(54) PATENT ASSESSMENT METHOD BASED ON ARTIFICIAL INTELLIGENCE

(71) Applicant: ANYFIVE.CO.LTD, Seoul (KR)

(72) Inventors: KIJONG KIM, Seoul (KR); WONJOON JANG, Gyeonggi-do (KR)

(21) Appl. No.: 17/577,029

(22) Filed: Jan. 17, 2022

(30) Foreign Application Priority Data
Jan. 18, 2021 (KR) 10-2021-0006969

(51) Int. Cl. G06Q 50/18; G06N 3/04

(52) U.S. Cl. CPC G06Q 50/184; G06N 3/0454

(57) ABSTRACT

A patent assessment method based on artificial intelligence comprises obtaining assessment patent information of an assessment target patent and assessment corporate information of an assessment target corporate possessing the assessment target patent from a user terminal; generating an input signal based on the assessment corporate information and the assessment patent information; inputting the input signal to a pre-trained neural network of an embedded computer in a control device; inputting an output value of the neural network based on the input result of the neural network and a comparison signal pre-stored in a database in the control device to a pre-trained neural network; and transmitting a patent assessment information to the user terminal based on an input result of the neural network.

### CROSS-REFERENCE TO RELATED APPLICATION

This application claims priority to Korean Patent Application No. 10-2021-0006969, filed on Jan. 18, 2021, and all the benefits accruing therefrom under 35 U.S.C. § 119, the contents of which are incorporated by reference in their entirety.

### BACKGROUND

### 1. Field

The present disclosure relates to a patent assessment method based on artificial intelligence.

### 2. Description of the Related Art

Effective patent assessment is required in terms of protection and utilization of corporate technology. The importance of objectively evaluating the value of intangible assets in technology transfer, in-kind investment, and finance is being emphasized.

Various patent assessment models have been proposed, and although they are somewhat different depending on the purpose of use, they are generally not much different from assessment items such as technology, rights, business, and marketability and assessment methods that are graded through assessment indicators for detailed items.

Patented technology can lead to revenue generation through corporates in various ways, so the influence of corporates in evaluating patents cannot be ignored. However, it is necessary to sufficiently consider the mutual influence of the patent and the corporate, and among companies with various industries and different financial conditions, which corporate holds the patent, and among similar patents, the corporate holds the patent. There are effects that are caused, and an improved assessment model that can evaluate these mutual influences is required.

### SUMMARY

The present disclosure is directed to providing a patent assessment method based on artificial intelligence to obtains assessment patent information about the assessment target patent and assessment corporate information about the assessment target corporate that has the assessment target patent, generates an input signal based on assessment patent information and assessment corporate information, and generates patent assessment information based on a result of inputting an output value based on a result input to a neural network and a comparison signal into a neural network.

To achieve the object, a patent assessment method based on artificial intelligence according to an embodiment of the present disclosure includes: obtaining assessment patent information of an assessment target patent and assessment corporate information of an assessment target corporate possessing the assessment target patent from a user terminal; generating an input signal based on the assessment corporate information and the assessment patent information; inputting the input signal to a pre-trained neural network of an embedded computer in a control device; inputting an output value of the neural network based on the input result of the neural network and a comparison signal pre-stored in a database in the control device to a pre-trained neural network; and transmitting a patent assessment information to the user terminal based on an input result of the neural network.

According to an embodiment of the present disclosure, generating the input signal includes generating a first input signal based on the assessment corporate information, and generating a second input signal based on the assessment patent information; inputting the input signal includes inputting the first input signal and the second input signal to a pre-trained corporate classification neural network of an embedded computer in a control device, and inputting the first input signal and the second input signal to a pre-trained patent classification neural network of an embedded computer in a control device; inputting the output value of the neural network and the comparison signal includes inputting an output value of the corporate classification neural network and a first comparison signal pre-stored in a database in the control device to a pre-trained first neural network based on an input result of the corporate classification neural network, and inputting an output value of the patent classification neural network and a second comparison signal pre-stored in a database in the control device to a pre-trained second neural network based on an input result of the patent classification neural network; and transmitting the patent assessment information includes generating patent assessment information based on input results of each of the first neural network and the second neural network.

According to an embodiment of the present disclosure, the corporate classification neural network takes as an input a first input signal encoding the assessment corporate information including at least one of industry information, financial information, and stock price information of the assessment target corporate, and a second input signal encoding the assessment patent information including at least one of the classification code, the number of forward cited documents, the number of backward cited documents, and the number of claims of the assessment target patent, and the corporate classification neural network outputs a unique corporate classification value for the assessment target corporate based on the input; and the patent classification neural network is takes as an input a first input signal encoding the assessment corporate information including at least one of industry information, financial information, and stock price information of the assessment target corporate, and a second input signal encoding the assessment patent information including at least one of the classification code, the number of forward cited documents, the number of backward cited documents, and the number of claims of the assessment target patent, and the patent classification neural network outputs a unique patent classification value for the assessment target patent based on the input.

According to an embodiment of the present disclosure, the first neural network takes as an input the first comparison signal for companies having a corporate classification value within a preset range within the corporate classification value of the assessment target corporate in the corporate information stored in the database, and output value of the corporate classification neural network, and the first neural network calculates corporate assessment index of the assessment target corporate by comparing the information obtained from the first comparison signal and the output value of the corporate classification neural network, and learns through a first learning signal according to the user's input; and the second neural network takes as an input the second comparison signal for patents having a patent classification value within a preset range within the patent classification value of the assessment target patent in the patent information stored in the database, and output value of the patent classification neural network, and the second neural network calculates patent assessment index of the assessment target patent by comparing the information obtained from the second comparison signal and the output value of the patent classification neural network, and learns through a second learning signal according to the user's input.

According to an embodiment of the present disclosure, the patent classification neural network further includes as an input a third input signal embedding contents described in one or more items of the patent specification including claims of the assessment target patent.

According to the present invention, by reflecting the quantitative characteristics of the patent along with the corporate's industry classification, financial status, and investment status in the corporate classification value, it is possible to confirm the characteristic implicating the relevance of the patent to corporate management, and by reflecting the quantitative characteristics of the corporate together with the characteristics such as the patent citation index and the strength of rights, including quantitative and qualitative characteristics of the patent in the patent classification value, it is possible to understand the characteristics of the corporate's relevance to the influence of the patent.

However, the effects of the present invention are not limited to the above-mentioned effects, and other effects not mentioned will be clearly understood by those skilled in the art from the following description.

### BRIEF DESCRIPTION OF THE DRAWINGS

FIG. 1 is a flowchart illustrating a patent assessment method based on artificial intelligence according to an embodiment.

FIG. 2 is a diagram for explaining a corporate classification neural network and a patent classification neural network according to an embodiment.

FIG. 3 is a configuration diagram for explaining a patent assessment method based on artificial intelligence according to an embodiment.

FIG. 4 is a diagram for describing a first neural network and a second neural network according to an embodiment.

FIG. 5 is an exemplary diagram of a configuration of an device according to an embodiment.

### DETAILED DESCRIPTION

Hereinafter, a patent assessment method based on artificial intelligence according to an embodiment of the present disclosure is described with reference to the accorporateing drawings.

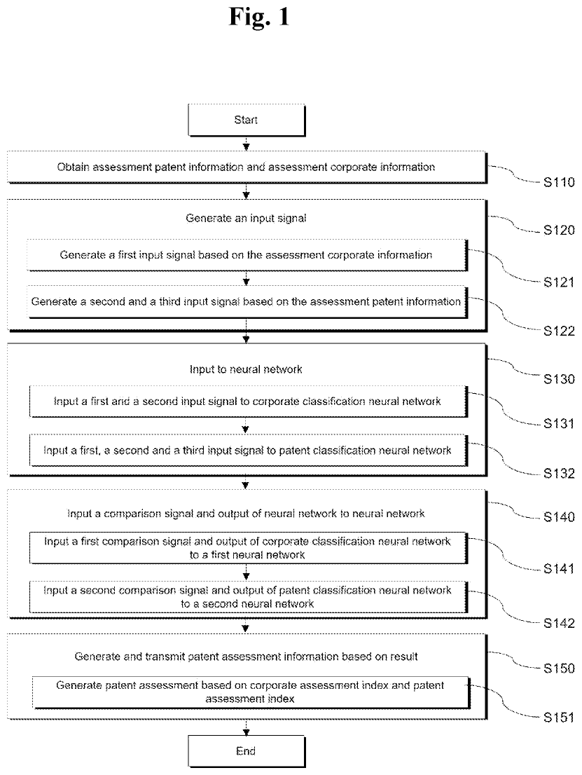

FIG. 1 is a flowchart illustrating a patent assessment method based on artificial intelligence according to an embodiment.

A control device for patent assessment based on artificial intelligence (hereinafter, a control device) includes a processor, a memory, a user interface, and a communication interface, and may be connected to other electronic devices through a network. The communication interface may transmit/receive data to and from another electronic device within a predetermined distance through a wired or wireless network or wired serial communication. The network enables wired and wireless communication between the electronic device and various entities according to an embodiment. The electronic device may communicate with various entities over a network, and the network may use standard communication technologies and/or protocols. At this time, the network includes, but is not limited to, the Internet, a local area network (LAN), a wireless local area network (Wireless LAN), a wide area network (WAN), a personal area network (PAN), and the like, and a person skilled in the art of communication technology can recognize that it may be another type of network capable of transmitting and receiving information.

The user terminal according to an embodiment may be an electronic device including a communication function. For example, the user terminal may include at least one of a smart phone, a tablet personal computer (PC), a mobile phone, a video phone, an e-book reader, a desktop PC (desktop personal computer), a laptop PC (laptop personal computer), netbook computer, PDA (personal digital assistant), PMP (portable multimedia player), MP3 player, mobile medical device, camera, or wearable device, for example, head-mounted-device (HMD) such as electronic glasses, electronic apparel, electronic bracelets, electronic necklaces, electronic accessories, electronic tattoos, smart cars, or smartwatches.

A patent assessment system according to an embodiment may include a server including a control device for patent assessment and a user terminal. The server according to an embodiment may be an evaluator's own server, a cloud server, or a peer-to-peer (p2p) set of distributed nodes. The server may be configured to perform all or part of an arithmetic function, a storage/referencing function, an input/output function, and a control function of a normal computer. The server may include at least one artificial neural network that performs an inference function. The server may be linked with a web page or application for a user of the user terminal. The server may be configured to communicate with the user terminal in a wired or wireless manner.

The patent assessment method based on artificial intelligence according to an embodiment includes the steps of obtaining assessment patent information about the assessment target patent and assessment corporate information about the assessment target corporate having the assessment target patent from the user terminal (S110), generating an input signal based on the assessment corporate information and the assessment patent information (S120), inputting the input signal into a pre-trained neural network of an embedded computer in the control device (S130), inputting the output value of the neural network based on the input result of the neural network and the comparison signal pre-stored in the database in the control device to the pre-trained neural network (S140), and transmitting the patent assessment information to the user terminal based on the input result of each neural network (S150).

According to an embodiment of the present invention, the step S120 of generating the input signal may include a step S121 of generating a first input signal based on the assessment corporate information and a step S122 of generating a second input signal and a third input signal based on the assessment patent information. The step S130 may include a step S131 of inputting the first input signal and the second input signal into a pre-trained corporate classification neural network of an embedded computer in the control device, and a step S132 of inputting the first input signal, the second input signal, and the third input signal into a pre-trained patent classification neural network of the control device. The step S140 may include a step S141 of inputting an output value of the corporate classification neural network based on an input result of the corporate classification neural network and a first comparison signal pre-stored in the database in the control device to a pre-trained first neural network, and a step S142 of inputting an output value of the patent classification neural network based on an input result of the patent classification neural network and a second comparison signal pre-stored in the database in the control device to a pre-trained second neural network. The step S150 of transmitting the patent assessment information may include a step S151 of generating patent assessment information based on an input result of each of the first neural network and the second neural network.

The server according to an embodiment obtains assessment patent information on the assessment target patent and assessment corporate information on the assessment target corporate having the assessment target patent from the user terminal (step S110).

The assessment patent information includes bibliographic information such as application number, application date, title of invention, and classification code that can identify the patent to be evaluated, additional information such as the number of forward cited documents, the number of backward cited documents, the number of claims, and the number of family applications, and claims, background art, and the description of the invention, such as the effect of the invention. The assessment corporate information is information about the corporate that is the current right holder that currently holds the assessment target patent, and may include financial information, industry type information, stock price information, and the like of the corresponding corporate. In one embodiment, the server may obtain identification information for identifying the assessment target patent and the assessment target corporate from the user terminal and call the assessment patent information and the assessment corporate information stored in the database in the control device based on the identification information.

According to an embodiment, the server may generate an input signal based on the assessment corporate information and the assessment patent information (step S120). According to an embodiment, the server may generate a first input signal based on the assessment corporate information (step S121) and generate a second input signal and a third input signal based on the assessment patent information (step S122).

According to an embodiment, the server may input the generated input signal to a pre-trained neural network of an embedded computer in the control device (step S130). According to an embodiment, the server inputs the first input signal and the second input signal to the pre-trained corporate classification neural network of the embedded computer in the control device (step S131), and inputs the first input signal, the second input signal, and the third input signal to the pre-trained patent classification neural network of the embedded computer in the control device (step S132).

Each of the corporate classification neural network and the patent classification neural network according to an embodiment is composed of a feature extraction neural network and a classification neural network, and the feature extraction neural network may sequentially include stack with a convolutional layer and a pooling layer. The convolution layer may include a convolution operation, a convolution filter, and an activation function. The calculation of the convolution filter may be adjusted according to the matrix size of the target input. The activation function typically uses, but is not limited to, a ReLU function, a sigmoid function, and a tan h function. The pooling layer is a layer that reduces the size of the input matrix, and uses a method of extracting representative values from pixels in a specific area. In general, the average value or the maximum value is often used for the calculation of the pooling layer, but it is not limited thereto. The convolutional layer and the pooling layer can be iterated alternately until the corresponding input becomes small enough while maintaining the difference.

According to one embodiment, the classification neural network has a hidden layer and an output layer. In the corporate classification neural network and the patent classification neural network for the patent assessment method, three or more hidden layers may exist, and 100 nodes of each hidden layer are designated, but more may be specified in some cases. The activation function of the hidden layer uses a ReLU function, a sigmoid function, and a tan h function, but is not limited thereto. A total of 50 output layer nodes of a convolutional neural network can be made.

According to an embodiment, the server may input an output value of the neural network based on the input result of the neural network and a comparison signal pre-stored in a database in the control device to the pre-trained neural network (step S140). According to an embodiment, the server may input the output value of the corporate classification neural network based on the input result of the corporate classification neural network and the first comparison signal pre-stored in the database in the control device to the pre-trained first neural network (step S141), and may input an output value of the patent classification neural network based on the input result of the patent classification neural network and a second comparison signal pre-stored in a database in the control device to the pre-trained second neural network (step S142).

According to an embodiment, the server may use an output signal pre-stored in the database as an input to the neural network. The output signal including the first comparison signal and the second comparison signal used as the input may be used for analyzing the output value resulted from the operation of the corporate classification neural network and the patent classification neural network, and utilizing the information accumulated in the output signal.

According to an embodiment, the server may transmit patent assessment information to the user terminal based on input results of each neural network (step 150). The server may generate patent assessment information based on input results of each of the first neural network and the second neural network (step 151).

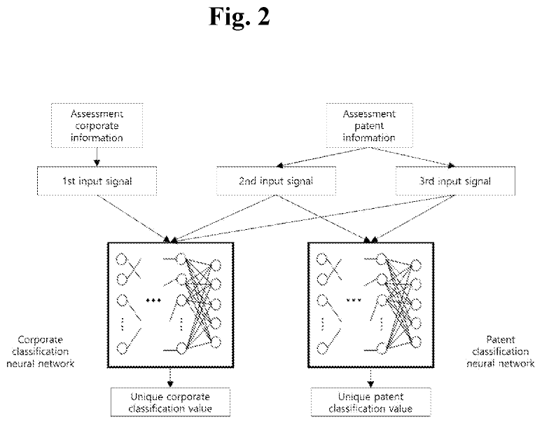

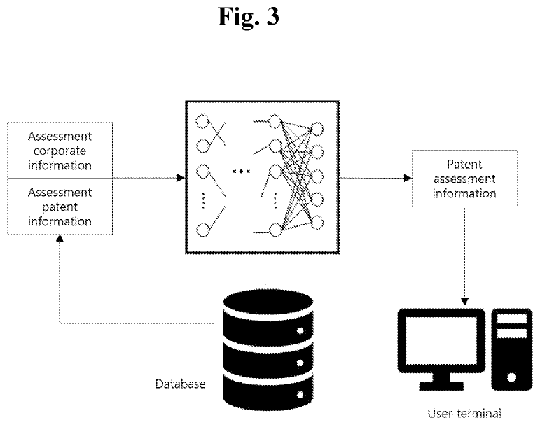

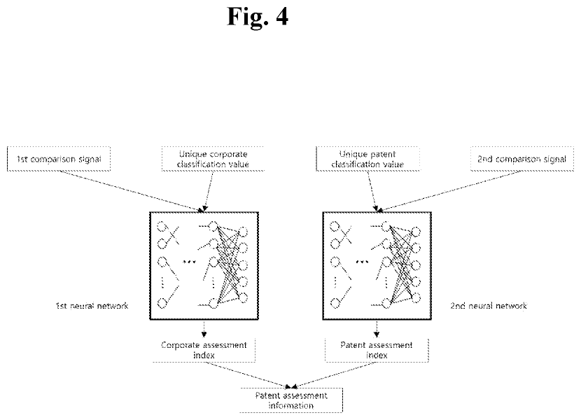

FIG. 2 is a diagram for explaining a corporate classification neural network and a patent classification neural network according to an embodiment. FIG. 3 is a configuration diagram for explaining a patent assessment method based on artificial intelligence according to an embodiment. FIG. 4 is A diagram for explaining a first neural network and a second neural network according to an embodiment.

According to an embodiment, the corporate classification neural network includes a first input signal by encoding the assessment corporate information including one or more of industry information, financial information, and stock price information of the assessment target corporate, and a second input signal by encoding the assessment patent information including at least one of the classification code of the assessment target patent, the number of forward cited documents, the number of backward cited documents, and the number of claims as an input, and includes a unique corporate classification value for the assessment target corporate based on the input as an output. The patent classification neural network includes a first input signal by encoding the assessment corporate information including one or more of industry information, financial information, and stock price information of the assessment target corporate, and a second input signal by encoding the assessment patent information including one or more of a classification code of the assessment target patent, the number of forward cited documents, the number of backward cited documents, and the number of claims as an input, and includes a unique patent classification value for the assessment target patent based on the input as an output.

According to an embodiment of the present invention, the first neural network may include an output value of the corporate classification neural network and the first comparison signal related to corporates having a business classification value in a preset range to the business classification value of the assessment target corporate among the corporate information stored in the database as an input, result in calculation of the corporate assessment index of the assessment target corporate by comparing the information obtained from the first comparison signal with the output value of the corporate classification neural network, and be trained through a first learning signal according to the user's input. The second neural network may include the second comparison signal related to patents having a patent classification value in a preset range to the patent classification value of the assessment target patent among the patent information stored in the database as an input, result in calculation of the patent assessment index of the assessment target patent by comparing the information obtained from the second comparison signal with the output value of the patent classification neural network, and be trained through a second learning signal according to the user's input.

According to an embodiment of the present invention, the patent classification neural network may further include, as an input, a third input signal in which the contents described in one or more items of the specification including the claims of the assessment target patent are embedded.

The unique corporate classification value and the unique patent classification value obtained through each corporate classification neural network and the patent classification neural network may be input to each of the first neural network and the second neural network. The corporate classification value is output through the corporate classification neural network based on the first and second input signals with reflecting the quantitative characteristics of the patent along with the corporate's industry classification, financial status, and investment status, so that the characteristics implying the relevance of patents to corporate management can be recognized therefrom. The patent classification value is output through a patent classification neural network based on the first input signal to the third input signal, with reflecting the corporate's qualitative and quantitative characteristics such as patent citation index and right strength, so that the characteristics implying the corporate's relevance to the influence of patents can be recognized therefrom.

The first neural network receives a first comparison signal for companies having a corporate classification value within a preset range to a corporate classification value for the assessment target corporate along with a unique corporate classification value, so that the corporate assessment index of the assessment target corporate can be calculated. The first comparison signal is information on companies whose corporate classification values derived based on corporate type information, financial information, stock price information, etc. are within a certain range, and can be derived as a relative indicator of the assessment target corporate compared to the corresponding companies. The first comparison signal may be information on each of the companies included in two or more different ranges. The first comparison signal may be, for example, information on companies that can be determined to be similar to the assessment target corporate in some characteristics such as industry type and financial status within a predetermined range. In addition, the first comparison signal may be information on companies that can be determined to be different from the assessment target corporate in some characteristics such as industry type and financial status within a range outside a predetermined range. The corporate assessment index may be calculated as a statistical value forming a standard normal distribution with respect to expected financial information, expected stock price information, and the like of the corporate.

The second neural network may receive a second comparison signal for patents having a patent classification value in a preset range with a patent classification value for the assessment target patent along with a unique patent classification value to obtain a patent assessment index of the assessment target patent. The second comparison signal is information on patents whose patent classification value is within a predetermined range and may derive a relative index of an assessment target patent by comparison with the corresponding patents. The second comparison signal may be information on each of the patents included in two or more different ranges. The second comparison signal may be, for example, information on patents that can be determined to be like the assessment target patent and some or all characteristics such as classification code, citation degree, and right strength within a predetermined range. In addition, the second comparison signal may be information on patents that can be determined to be different from the assessment target patent and some or all characteristics such as classification code, citation, and right strength are included in a range outside a predetermined range. These patent assessment indexes can be calculated as statistical values forming a standard normal distribution for the strength of patent rights, invalidity, monetization potential, and sales contribution.

According to an embodiment, the first neural network and the second neural network include a first learning signal generated by the correction information input by the user and it is possible to learn by receiving each of the second learning signals.

The first learning signal and the second learning signal according to an embodiment are created based on the error between the correction information and the output value, and in some cases, SGD using delta, a batch method, or a method following a backpropagation algorithm may be used. Based on this first learning signal, each neural network performs learning by correcting an existing weight, and in some cases, momentum may be used. A cost function may be used to calculate the error, and a cross entropy function may be used as the cost function.

According to an embodiment, in acquiring the corporate assessment index of the assessment target corporate and the patent assessment index of the assessment target patent, the computer controls the internal artificial intelligence (artificial neural network) to search the database, information can be updated. The artificial intelligence used at this time may be composed of a first neural network and a second neural network.

In one embodiment, the first neural network has a hidden layer and an output layer. In general, three or more hidden layers exist in the first neural network, and 100 nodes of each hidden layer are designated, but more or less may be specified in some cases. The activation function of the hidden layer uses a ReLU function, a sigmoid function, and a tan h function, but is not limited thereto. The number of output layer nodes of the first neural network may be 100 in total. The output layer activation function of the first neural network may use a softmax function, but is not limited thereto. The softmax function is a representative function of one-hot encoding, which makes the sum of all output nodes total 1, sets the output of the output node having the largest value to 1, and sets the output of the remaining output nodes to 0. It may be possible to select only one output out of 100 outputs via the softmax function.

The learning device may learn the first neural network through the first labels. The learning device may be the same as the control device, but is not limited thereto. The first neural network may be formed by calculating a loss function by comparing first training outputs obtained by inputting first labeled training input vectors with first labels. As the loss function, a known mean squared error (MSE), cross entropy error (CEE), etc. may be used. However, the present invention is not limited thereto, and as long as the deviation, error, or difference between the output of the first neural network and the label can be measured, loss functions used in various artificial neural network models may be used.

The learning device may optimize the first neural network based on the comparison value. By updating the weights of the nodes of the artificial neural network so that the learning device comparison value becomes smaller and smaller, the output of the artificial neural network corresponding to inference and the label corresponding to the correct answer can be gradually matched, and through this, the artificial neural network can be optimized to output inferences close to the correct answer. Specifically, the learning device may optimize the artificial neural network by repeating the process of resetting the weight of the artificial neural network so that the loss function corresponding to the comparison value approaches the estimated value of the minimum value. For the optimization of artificial neural networks, known backpropagation algorithms, stochastic gradient descent, etc. may be used. However, the present invention is not limited thereto, and a weight optimization algorithm used in various neural network models may be used.

In one embodiment, the second neural network has a hidden layer and an output layer. In general, there are three or more hidden layers in the second neural network, and 30 nodes of each hidden layer are designated, but more or less may be specified in some cases. The activation function of the hidden layer uses a ReLU function, a sigmoid function, and a tan h function, but is not limited thereto. The number of output layer nodes of the second neural network may be 10 in total. The output layer activation function of the second neural network may use a softmax function, but is not limited thereto.

The learning device may learn the second neural network through the second labels. The learning device may be the same as the control device, but is not limited thereto. The second neural network may be formed by calculating a loss function by comparing second training outputs obtained by inputting second labeled training input vectors with second labels. As the loss function, a known mean squared error (MSE), cross entropy error (CEE), or the like may be used. However, the present invention is not limited thereto, and as long as the deviation, error, or difference between the output of the second neural network and the label can be measured, loss functions used in various artificial neural network models may be used.

The learning device may optimize the second neural network based on the comparison value. By updating the weights of the nodes of the artificial neural network so that the learning device comparison value becomes smaller and smaller, the output of the artificial neural network corresponding to inference and the label corresponding to the correct answer can be gradually matched, and through this, the artificial neural network can be optimized to output inferences close to the correct answer. Specifically, the learning device may optimize the artificial neural network by repeating the process of resetting the weight of the artificial neural network so that the loss function corresponding to the comparison value approaches the estimated value of the minimum value. For the optimization of artificial neural networks, known backpropagation algorithms, stochastic gradient descent, etc. may be used. However, the present invention is not limited thereto, and a weight optimization algorithm used in various neural network models may be used.

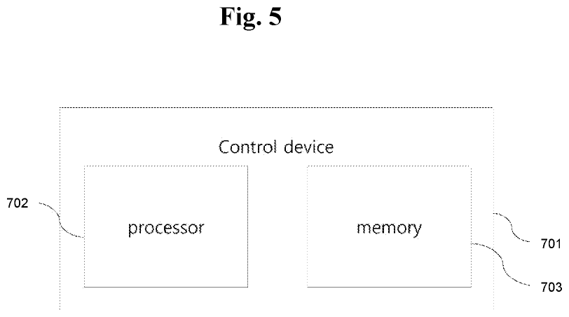

FIG. 5 is an exemplary diagram of a configuration of an device according to an embodiment.

The control device 701 according to one embodiment includes a processor 702 and a memory 703. The processor 702 may include at least one of the devices described above with reference to FIGS. 1 to 4, or perform at least one method described above with reference to FIGS. 1 to 4. Specifically, the device 701 may be the server 100, the user terminal 110, or an artificial neural network learning device.

The memory 703 may store information related to the above-described methods or a program in which the above-described methods are implemented. The memory 703 may be a volatile memory or a non-volatile memory.

The processor 702 may execute a program and control the device 701. Codes of programs executed by the processor 702 may be stored in the memory 703. The device 701 may be connected to an external device (eg, a personal computer or a network) through an input/output device (not shown), and may exchange data through wired/wireless communication.

The device 701 may be used to train an artificial neural network or to use a trained artificial neural network. The memory 703 may include a learning or trained artificial neural network. The processor 702 may learn or execute an artificial neural network algorithm stored in the memory 703. The device 701 for training an artificial neural network and the device 701 for using the trained artificial neural network may be the same or may be separate.

The embodiments described above may be implemented by a hardware component, a software component, and/or a combination of a hardware component and a software component. For example, the device, methods, and components described in the embodiments may include, for example, a processor, a controller, an arithmetic logic unit (ALU), a digital signal processor, a microcomputer, a field programmable (FPGA) and may be implemented using one or more general purpose or special purpose computers, such as a gate array), a programmable logic unit (PLU), a microprocessor, or any other device capable of executing and responding to instructions. The processing device may execute an operating system (OS) and one or more software applications running on the operating system. A processing device may also access, store, manipulate, process, and generate data in response to execution of the software. For convenience of understanding, although one processing device is sometimes described as being used, one of ordinary skill in the art will recognize that the processing device includes a plurality of processing elements and/or a plurality of types of processing elements. For example, the processing device may include a plurality of processors or one processor and one controller. Other processing configurations are also possible, such as parallel processors.

The method according to the embodiment may be implemented in the form of program instructions that can be executed through various computer means and recorded in a computer-readable medium. The computer-readable medium may include program instructions, data files, data structures, etc. alone or in combination. The program instructions recorded in the medium may be specially designed and configured for the embodiment, or may be known and available to those skilled in the art of computer software. Examples of the computer-readable recording medium include magnetic media such as hard disks, floppy disks and magnetic tapes, optical media such as CD-ROMs and DVDs, and magnetic such as floppy disks.—includes magneto-optical media, and hardware devices specially configured to store and execute program instructions, such as ROM, RAM, flash memory, and the like. Examples of program instructions include not only machine language codes such as those generated by a compiler, but also high-level language codes that can be executed by a computer using an interpreter or the like. A hardware device may be configured to operate as one or more software modules to perform the operations of the embodiments, and vice versa.

Software may include a computer program, code, instructions, or a combination of one or more of these, configure a processing device to operate as desired and command with the processing device independently or collectively. The software and/or data may be any kind of machine, component, physical device, virtual equipment, computer storage medium or device, to be interpreted by or to provide instructions or data to the processing device or may be permanently or temporarily embodied in a transmitted signal wave. The software may be distributed over networked computer systems and stored or executed in a distributed manner. Software and data may be stored in one or more computer-readable recording media.

Communication connection in the system and method according to the embodiments of the present invention may be configured regardless of communication aspects such as wired communication or wireless communication and may include a local area network (LAN), a metropolitan area network (MAN) Network) and a wide area network (WAN) may be configured as various communication networks. Preferably, the communication connection in the present specification may be a well-known Internet or World Wide Web (WWW). However, the communication connection is not necessarily limited thereto, and may include a known wired/wireless data communication network, a known telephone network, or a known wired/wireless television communication network in at least a part thereof. For example, the communication connection is a wireless data communication network, such as Wi-Fi communication, WiFi-Direct communication, Long Term Evolution (LTE) communication, and Bluetooth communication, infrared communication, ultrasonic communication, etc. may be implemented in at least a part of the conventional communication method. For another example, the communication connection may be an optical communication network, which implements at least a part of a conventional communication method such as LiFi (Light Fidelity).

Although the embodiments of the present invention have been described in more detail with reference to the drawings, the present invention is not necessarily limited to these embodiments, and various modifications may be made within the scope without departing from the technical spirit of the present invention. Accordingly, the embodiments disclosed in the present invention are not intended to limit the technical spirit of the present invention, but to explain, and the scope of the technical spirit of the present invention is not limited by these embodiments. Therefore, it should be understood that the embodiments described above are illustrative in all respects and not restrictive. The protection scope of the present invention should be construed by the following claims, and all technical ideas within the scope equivalent thereto should be construed as being included in the scope of the present invention.

What is claimed is:

1. A patent assessment method based on artificial intelligence, the method comprising:
obtaining assessment patent information of an assessment target patent and assessment corporate information of an assessment target corporate possessing the assessment target patent from a user terminal;
generating an input signal based on the assessment corporate information and the assessment patent information;
inputting the input signal to a pre-trained neural network of an embedded computer in a control device;
inputting an output value of the neural network based on the input result of the neural network and a comparison signal pre-stored in a database in the control device to a pre-trained neural network; and
transmitting a patent assessment information to the user terminal based on an input result of the neural network.

2. The method of claim 1, wherein generating the input signal includes generating a first input signal based on the assessment corporate information, and generating a second input signal based on the assessment patent information;
inputting the input signal includes inputting the first input signal and the second input signal to a pre-trained corporate classification neural network of an embedded computer in a control device, and inputting the first input signal and the second input signal to a pre-trained patent classification neural network of an embedded computer in a control device;
inputting the output value of the neural network and the comparison signal includes inputting an output value of the corporate classification neural network and a first comparison signal pre-stored in a database in the control device to a pre-trained first neural network based on an input result of the corporate classification neural network, and inputting an output value of the patent classification neural network and a second comparison signal pre-stored in a database in the control device to a pre-trained second neural network based on an input result of the patent classification neural network; and
transmitting the patent assessment information includes generating patent assessment information based on input results of each of the first neural network and the second neural network.

3. The method of claim 2, wherein the corporate classification neural network takes as an input a first input signal encoding the assessment corporate information including at least one of industry information, financial information, and stock price information of the assessment target corporate, and a second input signal encoding the assessment patent information including at least one of the classification code, the number of forward cited documents, the number of backward cited documents, and the number of claims of the assessment target patent, and wherein the corporate classification neural network outputs a unique corporate classification value for the assessment target corporate based on the input; and
wherein the patent classification neural network is takes as an input a first input signal encoding the assessment corporate information including at least one of industry information, financial information, and stock price information of the assessment target corporate, and a second input signal encoding the assessment patent information including at least one of the classification code, the number of forward cited documents, the number of backward cited documents, and the number of claims of the assessment target patent, and the patent classification neural network outputs a unique patent classification value for the assessment target patent based on the input.

4. The method of claim 3, wherein the first neural network takes as an input the first comparison signal for companies having a corporate classification value within a preset range within the corporate classification value of the assessment target corporate in the corporate information stored in the database, and output value of the corporate classification neural network, and wherein the first neural network calculates corporate assessment index of the assessment target corporate by comparing the information obtained from the first comparison signal and the output value of the corporate classification neural network, and learns through a first learning signal according to the user's input; and
wherein the second neural network takes as an input the second comparison signal for patents having a patent classification value within a preset range within the patent classification value of the assessment target patent in the patent information stored in the database, and output value of the patent classification neural network, and wherein the second neural network calculates patent assessment index of the assessment target patent by comparing the information obtained from the second comparison signal and the output value of the patent classification neural network, and learns through a second learning signal according to the user's input.

5. The method of claim 4, wherein the patent classification neural network further includes as an input a third input signal embedding contents described in one or more items of the patent specification including claims of the assessment target patent.
